(19) United States
(12) Patent Application Publication
(10) Pub. No.: US 2010/0044896 A1
(43) Pub. Date: Feb. 25, 2010

(54) Injection Molding Apparatus Having a Nozzle Tip Component for Taking a Nozzle Out of Service

(76) Inventors: Payman Tabassi, Rockwood (CA); Denis Babin, Georgetown (CA)

Correspondence Address: MOLD-MASTERS (2007) Limited, 233 ARMSTRONG AVENUE, INTELLECTUAL PROPERTY DEPARTMENT, GEORGETOWN, ON, L7G-4X5, CA

(21) Appl. No.: 12/196,267

(22) Filed: Aug. 21, 2008

(51) Int. Cl. B29C 45/23; B29C 45/76

(52) U.S. Cl. 264/39; 425/145

(57) ABSTRACT

A nozzle tip component for taking a nozzle of an injection molding apparatus out-of service, wherein the nozzle tip component has a tapered interior surface that circumferentially surrounds and grips an associated valve pin to lock the valve pin in a closed position and prevent flow of molding material. The injection molding apparatus includes a plurality of nozzles defining nozzle channels, each nozzle associated with a mold gate, and a plurality of valve pins releasably coupled to an actuated valve pin plate. Each valve pin extends through the one of the nozzles for controlling flow of molding material in the nozzle channel, and the actuated valve pin plate is operable to move the plurality of valve pins between open and closed positions of the mold gates.

### BACKGROUND OF THE INVENTION

1. Field of the Invention

This invention relates to an injection molding apparatus, and more particularly, an injection molding apparatus having a valve pin.

2. Related Art

Injection molding apparatuses, such as hot halves and hot runners, commonly use valve pins to control flow of molding material.

When a cavity, valve pin, heater, mold gate, or other related component wears or fails, the molded product may have defects and the injection molding apparatus may have to be shut down for maintenance or repair. Such downtime eats into production time, which is nearly always sought to be maximized.

### SUMMARY OF THE INVENTION

An injection molding apparatus, such as a hot half or hot runner, includes an actuated valve pin plate, a manifold defining a manifold channel, a plurality of nozzles defining nozzle channels in communication with the manifold, each nozzle associated with a mold gate, and a plurality of valve pins releasably coupled to the actuated valve pin plate. Each valve pin extends through the one of the nozzles for controlling flow of molding material in the nozzle channel. The actuated valve pin plate is operable to move the plurality of valve pins between open and closed positions of the mold gates. At least one nozzle includes a nozzle tip component having a tapered interior surface that circumferentially surrounds and grips the associated valve pin to lock the valve pin in the closed position and prevent flow of molding material.

### BRIEF DESCRIPTION OF THE FIGURES

Embodiments of the present invention will now be described more fully with reference to the accompanying drawings, where like reference numbers indicate similar structure.

FIG. 1 is a cross-sectional view of an injection molding apparatus according to an embodiment of the present invention.

FIG. 2 is a cross-sectional view of one of the magnetic couplings of FIG. 1.

FIG. 3 is a cross-sectional view of the injection molding apparatus of FIG. 1 showing the valve pins in their opened positions.

FIG. 4 is a cross-sectional view showing one of the valve pins of FIG. 1 immovable.

FIGS. 5a and 5b are cross-sectional views of one of the magnetic couplings of FIG. 1 shown in various positions.

FIG. 6 is an enlarged cross-sectional view of the nozzle tip area of the out-of-service nozzle, wherein the nozzle tip component for taking the nozzle out-of-service includes a locking liner and a retainer.

FIG. 7 is an enlarged cross-sectional view of an out-of-service nozzle tip area according to another embodiment of the invention.

FIG. 8 is a perspective view of a locking liner having a collet-type configuration according to another embodiment of the invention.

FIG. 9 is an enlarged cross-sectional view of an out-of-service nozzle tip area according to another embodiment of the invention.

### DETAILED DESCRIPTION OF THE INVENTION

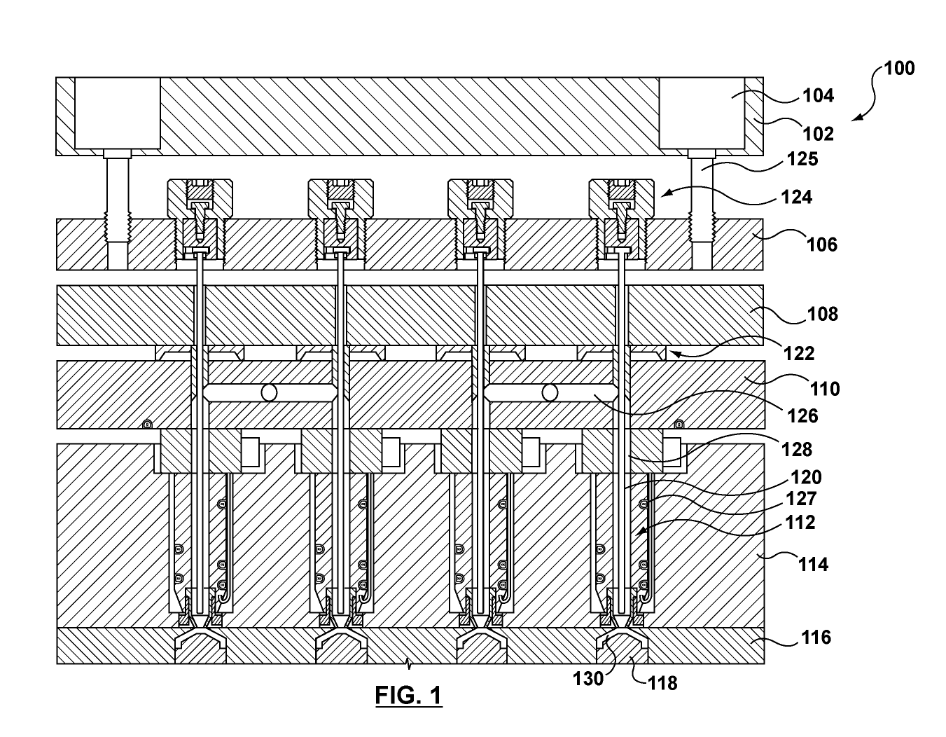

FIG. 1 shows an injection molding apparatus 100 according to an embodiment of the present invention. The features and aspects described for the other embodiments can be used accordingly with the present embodiment.

The injection molding apparatus includes an actuator plate 102, actuators 104, an actuated valve pin plate 106, a back plate 108, a manifold 110, nozzles 112, a mold plate 114, a cavity plate 116, cores 118, valve pins 120, valve pin bushings 122, and magnetic couplings 124. The injection molding apparatus 100 can include any number of manifolds and nozzles, in any configuration. In this embodiment, one manifold is shown for simplicity. The injection molding apparatus 100 can include additional components, such as mold plates, alignment dowels, mold gate inserts, and cooling channels, among others.

The actuator plate 102 has openings for accommodating the actuators 104. If the actuators 104 depend on a working fluid for operation (i.e., pneumatic or hydraulic types), fluid conduits can be provided in the actuator plate 102. Should the actuators 104 be electric or magnetic or of some other design, electrical conduits can be provided.

The actuators 104 are disposed in the actuator plate 102 and can be pneumatic, hydraulic, electric, magnetic, or of some other design. The actuators 104 can translate the valve pin plate 106 by linear motion (e.g., a pneumatic piston) or rotary motion (e.g., an electric screw drive). To accomplish this, each actuator 104 has a stationary part (e.g., a housing or cylinder) connected to the actuator plate 102 and has a movable part 125 (e.g., a piston) connected to the valve pin plate 106. The number of actuators is a design choice, and in other embodiments more or fewer actuators can be used. Any style of actuator is suitable, provided that it can move the valve pin plate 106.

The valve pin plate 106 is connected to the movable part 125 of each actuator 104. The valve pin plate 106 has a plurality of threaded openings for receiving the magnetic couplings 124. The valve pin plate 106 can move up and down in response to the actuation of the actuators 104. The valve pin plate 106 need not be a plate as such, but can be any rigid member capable of connecting one or more actuators to a plurality of magnetic couplings. In other embodiments, the valve pin plate 106 is an assembly of stacked plates.

The back plate 108 is disposed between the valve pin plate 106 and the valve pin bushings 122 and serves to secure the valve pin bushings 122 in the manifold 110. The back plate 108 has several bores through which the valve pins 120 extend.

The manifold 110 defines a manifold channel 126 and includes a manifold heater 127. The manifold channel 126 receives molding material (e.g., plastic melt) from an inlet component (not shown) or an upstream manifold (not shown). The manifold heater 127 can be of any design, such as the insulated resistance wire illustrated. It should also be mentioned that, because of the plate interconnections (not shown), the manifold 110 is stationary relative to the stationary parts of the actuators 104.

The nozzles 112 are connected to the manifold 110 and each nozzle 112 defines one of a plurality of nozzle channels 128 in communication with the manifold channel 126. In this embodiment, each nozzle 112 includes a nozzle body, a nozzle flange, a nozzle heater embedded in the nozzle body, a thermocouple, a terminal end for connecting the heater to a power source, a nozzle tip, and a tip retainer. The nozzles 112 in combination with the manifold 110 define a hot runner.

The mold plate 114 has wells to accommodate and support the nozzles 112. The wells are sized to thermally insulate the nozzles 112 from the surrounding material.

The cavity plate 116 and the cores 118 define cavities 130, and the cavity plate 116 defines mold gates leading to the cavities 130. The cavity plate 116 and cores 118 are separable from the mold plate 114 along a parting line to allow ejection of molded products from the cavities 130. In other embodiments, a single cavity can be fed molding material by several nozzles 112.

Each of the valve pins 120 extends from one of the magnetic couplings 124 to one of the nozzles 112 for controlling flow of molding material through the mold gates and into the cavities 130.

Each valve pin bushing 122 is held to the manifold 110 by the back plate 108. Each valve pin bushing 122 includes a disc-shaped main body and a cylindrical bushing portion connected to and extending from the main body and into the manifold 110. Each valve pin bushing 122 has a valve pin bore, which creates a seal with the valve pin 120 while still allowing the valve pin 120 to slide.

Each magnetic coupling 124 couples a respective valve pin 120 to the valve pin plate 106. Each magnetic coupling 124 directly transmits actuator closing force to the respective valve pin 120 when the valve pins 120 are being closed (i.e., moved down). Each magnetic coupling 124 also applies a magnetic force to move the respective valve pin 120 when the valve pins 120 are being opened (i.e., moved up). During normal operation, the magnetic force is sufficient to keep the valve pins 120 coupled to the valve pin plate 106 when the valve pins 120 are opened and closed. If one of the valve pins becomes immovable, the respective magnetic force is overcome by an actuator opening force so that the valve pin plate 106 and remaining valve pins 120 move (i.e., up) with respect to the immovable valve pin. It should be noted that the directions indicated above are reversed if the valve pins 120 are designed to open flow of molding material when moved down and to close flow when moved up. The magnetic couplings 124 are described in more detail below. Further, the magnetic couplings 124 are described in more detail in U.S. patent application Ser. No. 11/876,706, filed Oct. 22, 2007, which is herein incorporated by reference in its entirety.

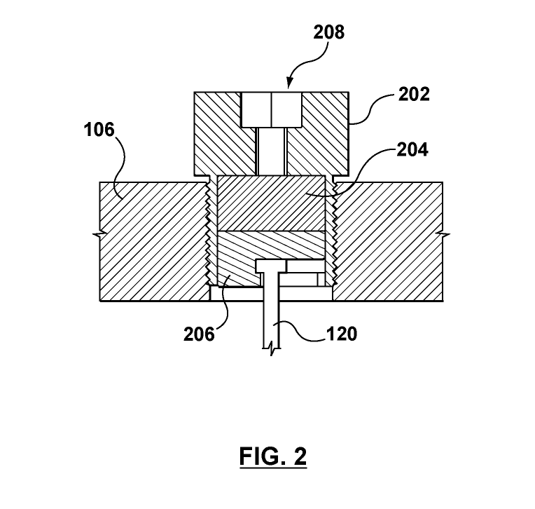

FIG. 2 is a cross-sectional view of one of the magnetic couplings 124. The magnetic coupling 124 includes a housing 202, a first magnetic part 204, and a second magnetic part 206.

The housing 202 connects the first magnetic part 204 to the valve pin plate 106. The housing 202 is threaded into a threaded bore of the valve pin plate 106. A bore 208, which can also be threaded, is provided through the back end of the housing 202.

The first magnetic part 204 is connected to the valve pin plate 106 via the housing 202 and thus moves with the valve pin plate 106. The first magnetic part is 204 is inserted into the housing 202 and fixed to the housing 202 by way of magnetic attraction when the housing 202 is made of a magnetically responsive material such as steel. If the housing 202 is not made of a magnetically responsive material or if additional fixing force is required, an adhesive or a tight friction fit can be used, for example. A tool can be inserted into the bore 208 of the housing 202 to push the first magnetic part 204 free from the housing 202.

The second magnetic part 206 is positioned below the first magnetic part 204 and close enough to establish a magnetic force with the first magnetic part 204. In this embodiment, the second magnetic part 206 is attractively aligned with the first magnetic part 204 and the resulting the magnetic force is an attractive magnetic force. The second magnetic part 206 is slidable in the housing 202 and is thus moveable with respect to the first magnetic part 204. The second magnetic part 206 has a T-shaped slot for receiving the head of the valve pin 120, so that the second magnetic part 206 and the valve pin 120 are connected and can move together. By way of its location, the first magnetic part 204 defines a stopped position of the second magnetic part 206 relative to the first magnetic part 204 (and thus to the valve pin plate 106), and the attractive magnetic force tends to force the second magnetic part 206 into the stopped position. When the second magnetic part 206 is pulled away from the first magnetic part 204, the attractive magnetic force tends to pull the second magnetic part 206 back towards the first magnetic part 204 and into the stopped position.

In one embodiment, the first magnetic part 204 is a permanent magnet, such as a neodymium magnet or a samarium-cobalt magnet, and the second magnetic part 206 includes magnetically responsive material, such as steel, iron, or similar. The choice between a neodymium magnet, a samarium-cobalt magnet, and a magnet of some other material should be made addressing concerns such as temperature exposure and impact during operation. Magnetically responsive material can be ferromagnetic, ferrous material, or any other kind of material that experiences a significant force in the presence of a magnetic field. In this embodiment, the second magnetic part 206 is made of steel. In other embodiments, the first magnetic part 204 can be of a magnetically responsive material and the second magnetic part 206 can be a permanent magnet, or both parts 204, 206 can be some combination of permanent magnets and electromagnets. It should be noted that embodiments of the valve pin plate injection molding apparatuses described herein may include alternate designs than magnetic couplings 124 for coupling a respective valve pin 120 to the valve pin plate 106. For example, the injection molding apparatus may include spring couplings such as those described in U.S. Pat. No. 7,210,922, herein incorporated by reference, rather than magnetic couplings 124.

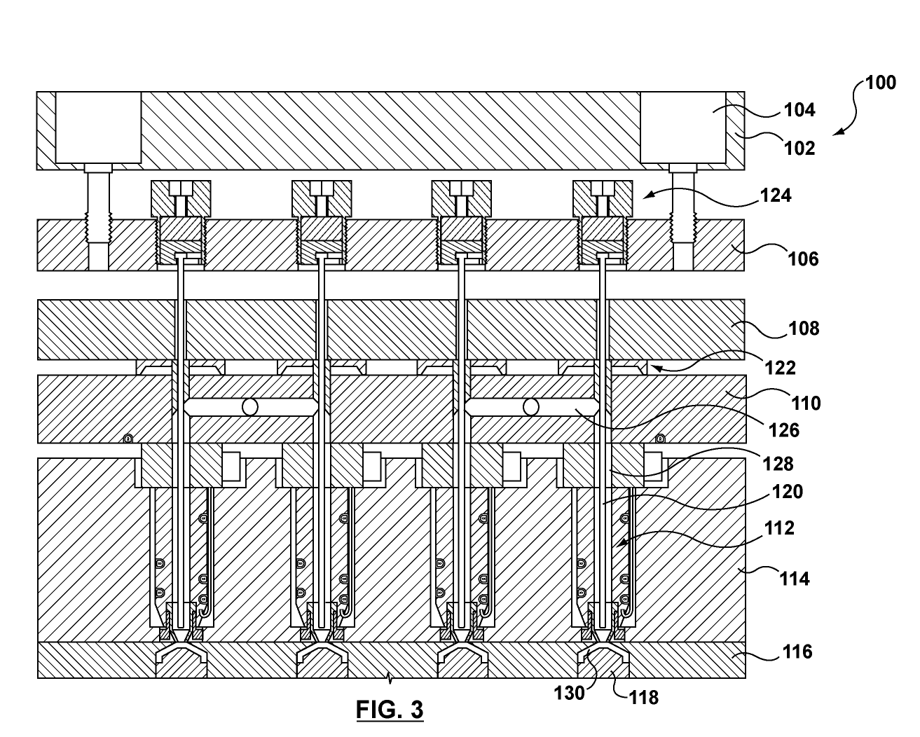

In FIG. 1 the valve pins 120 are in their closed positions, such that molding material is prevented from flowing through the mold gates and into the cavities 130. FIG. 3, on the other hand, shows the valve pins 120 in their opened positions, such that molding material can flow through the mold gates and into the cavities 130. As can be seen in FIG. 3, the actuators 104 have moved the valve pin plate 106 up thereby moving the magnetic couplings 124, which, by way of attractive magnetic forces, pull the valve pins 120 up. When the valve pins 120 are to be returned to their closed positions (FIG. 1), the valve pin plate 106 moves down, which causes the magnetic couplings 124 to rigidly (i.e., independently of magnetic forces) push the valve pins 120 down.

As described in U.S. patent application Ser. No. 11/876,706, filed Oct. 22, 2007, solidified molding material may be utilized to hold a valve pin associated with an out-of-service nozzle in a closed position. More particularly, the nozzle heater may be shut down such that solidified or cooled molding material immobilizes the valve pin. That is, when a nozzle is to be taken out of service because of a worn valve pin or leaking cavity, the nozzle's heater can be shut down to stop molding material from flowing. Solidified molding material can also occur if a nozzle heater fails. The magnetic couplings 124 are designed to have a magnetic force less than the expected immobilizing force, such that the magnetic couplings 124 will allow for continued operation of valve pins when one or more nozzles are taken out of service. Shutting down the nozzle's heater also helps to prevent drooling in the out-of-service nozzle.

However, in some applications, the solidified melt around the valve pin may not be sufficient to completely immobilize the out-of-service valve pin such that it is prevented from moving up and down with the other valve pins because the magnetic force of the magnetic couplings 124 (or other attractive force if magnetic couplings 124 are not present) is greater than the immobilizing force. In some instances, heat elsewhere in the apparatus may prevent the melt from sufficiently solidifying. Further, taking the valve pin out of service by solidified melt causes a small force on the valve pin plate 106 as the immobilizing force of the melt overcomes the magnetic force between the plate and the valve pins. If several valve pins are out-of-service, this small force is multiplied and may damage the magnets of the magnetic couplings.

Thus, in addition to turning off the nozzle heater in order to immobilize the out-of-service valve pin, the present invention is directed to embodiments of a nozzle tip component that may be installed for taking a nozzle of an injection molding apparatus out of service. Embodiments of the present invention include a retainer and/or a locking liner at the nozzle tip area that grips a valve pin associated with the nozzle selected to be taken out of service in order to maintain the valve pin in a closed position. The retainer can also have a seal portion to prevent leakage past the nozzle tip area and into the well.

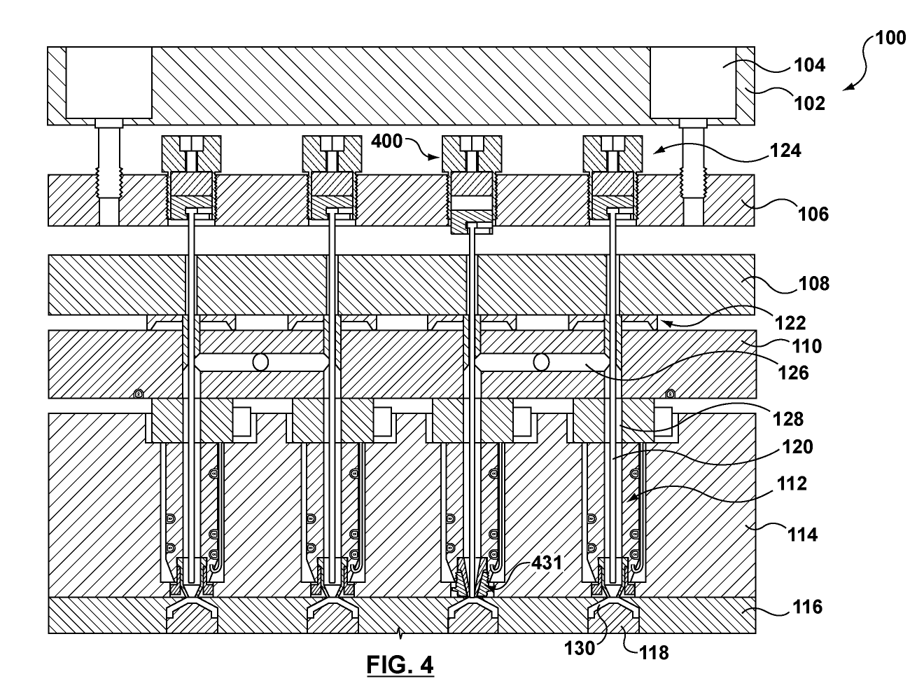

Turning now to FIG. 4, a cross-sectional view is shown in which one of nozzles 112 has been taken out of service by immobilizing the associated valve pin 120 via a nozzle tip component 431. Valve pin 120 located at 400 has become immovable because it is held in the closed position by an immobilizing force. As can be seen, three of the valve pins 120 are open, as pulled by the valve pin plate 106 via the magnetic couplings 124; while one valve pin 120 at 400 is closed, despite the pull of the valve pin plate 106. As shown, the magnetic coupling 124 connected to the closed valve pin 120 has reacted to the immobilizing force and has extended to compensate for the movement of the valve pin plate 106.

A selected nozzle 112 can be taken out of service by closing the valve pins 120, removing the nozzle tip that is utilized when the nozzle is in-service, and installing nozzle tip component 431. That is, when a nozzle is to be taken out of service, a nozzle tip component 431 may be installed in order to maintain the valve pin in a closed position. The nozzle tip component 431 creates a definite out-of-service position that prevents unwanted travel of the valve pin in an out-of-service nozzle, because such unwanted travel may damage the magnets in the magnetic couplings 124. More particularly, if space permits, the valve pin may be pulled closer to the mold cavity than usual when installing the nozzle tip component 431 to completely disengage the magnet of the magnetic coupling to further reduce the possibility of damaging the magnet contact surfaces. Once the selected valve pin 120 is immobilized, the magnetic couplings 124 allow the valve pin plate 106 to still actuate the remaining in-service valve pins 120. The injection molding apparatus 100 can be restarted as usual, and the selected valve pin 120 of the immobilized nozzle will remain stationary.

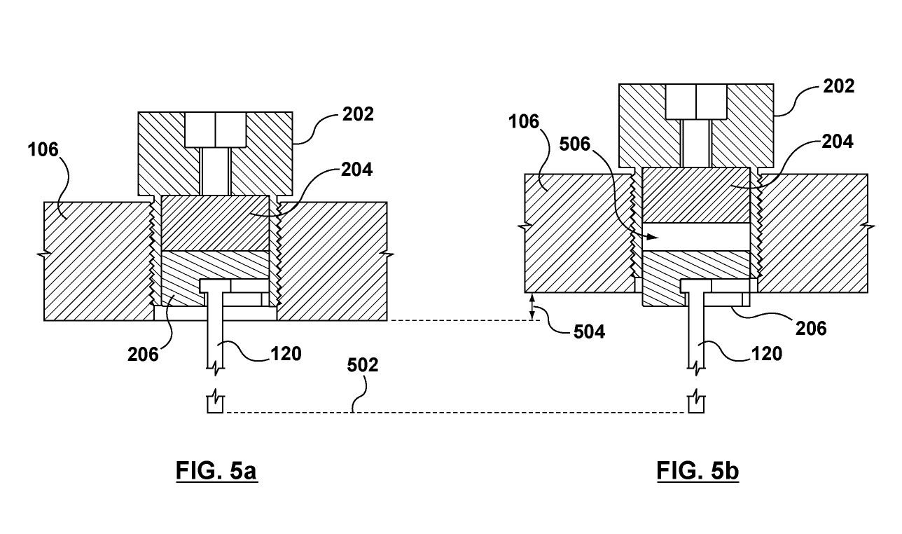

FIGS. 5a and 5b show a magnetic coupling 124 associated with an immobilized valve pin 120. FIG. 5a shows the valve pin plate 106 down and the valve pin 120 closed, while FIG. 5b shows the valve pin plate 106 up and the valve pin 120 still closed. As indicated at 502, the valve pin 120 stays in the closed position even though the valve pin plate 106 has moved upwards by a distance 504 (which, in this embodiment, is equivalent to the valve pin travel). The first magnetic part 204 has moved upwards relative to the second magnetic part 206, which has remained stationary with the fixedly connected valve pin 120. Viewed with the valve pin plate taken as a reference, the second magnetic part 206 has slid within the housing 202 away from the first magnetic part 204. As such, a gap 506 (which, in this embodiment, is also equivalent to the valve pin travel) separates the first and second magnetic parts 204, 206. The attractive magnetic force can be viewed as acting within the gap 506 to tend to bring the first and second magnetic parts 204, 206 closer together.

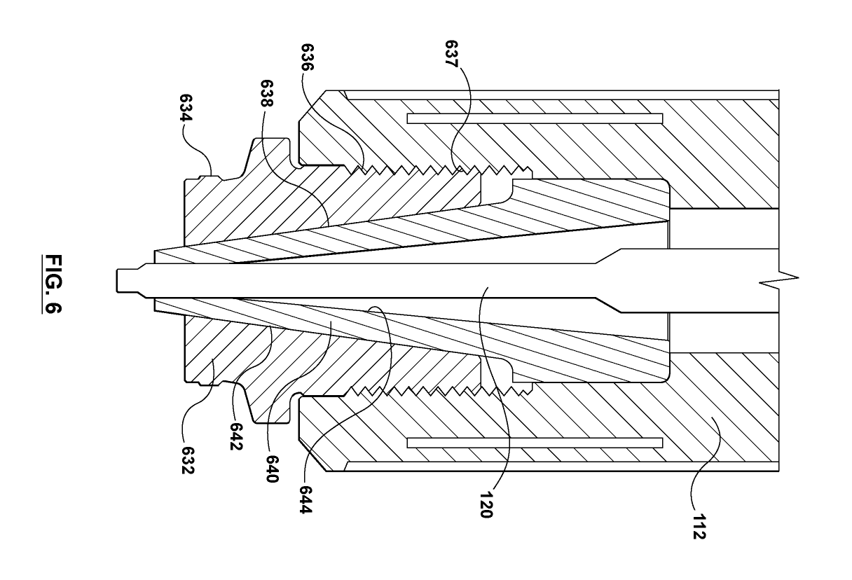

FIG. 6 is an enlarged cross-sectional view of the out-of-service nozzle tip area according to one embodiment of the invention. In this embodiment, the nozzle tip component for taking the nozzle out-of-service includes a retainer 632 and locking liner 640. When it is desirable to take a nozzle out-of-service, the nozzle tip of the nozzle is removed and replaced with retainer 632 and locking liner 640. At the nozzle tip area, the valve pin 120 fits into liner 640. Liner 640 is conical in shape and has an interior tapered surface 644 for contacting the valve pin 120 and an exterior tapered surface 642 for contacting the retainer 632. Liner 640 is formed from a thin piece of material that deforms when retainer 632 is tightened such that liner 640 grips the valve pin 120 in a friction fit. Suitable materials for the liner 640 include metals, such as steel and beryllium copper, as well as plastics, such as polyimide-based polymers (e.g., VESPEL). Aside from mechanical deformation characteristics for gripping the valve pin as well as sealing against leakage, resistance to operating temperatures and relative thermal expansion of the selected material can be taken into account to meet the expected service life and resist leakage, respectively. Retainer 632 has an interior tapered surface 638 that matches or corresponds to exterior tapered surface 642 of liner 640. In addition, retainer 632 includes an exterior surface 634 including threads 636 located where an outside surface of retainer 632 is threaded into an interior surface of nozzle 112. Threads 636 mate with threads 637 on an interior surface of nozzle 112. When the retainer 632 is threaded into nozzle 112, retainer 632 compresses the locking liner 640 around valve pin 120 to immobilize valve pin 120 and seal the nozzle tip area to prevent leakage/drooling in the out-of-service nozzle.

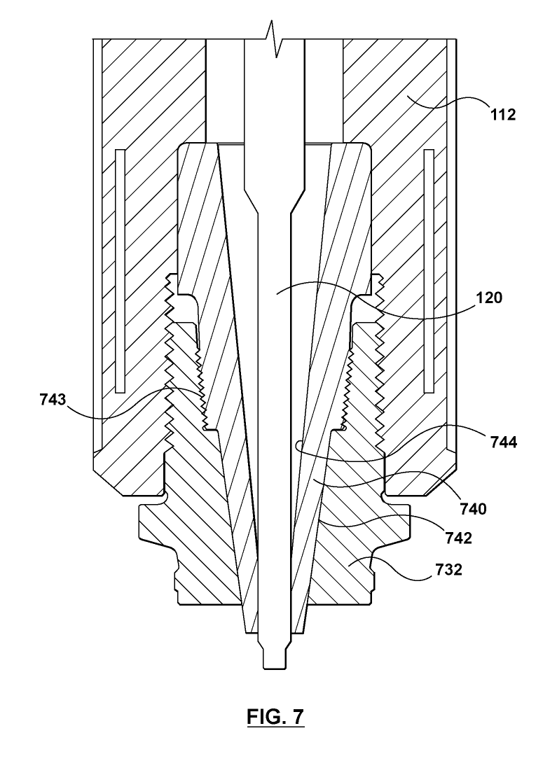

In another embodiment, the exterior tapered surface of the locking liner may include one or more threads. As shown in FIG. 7, a liner 740 has an interior tapered surface 744 for contacting a valve pin 120 and an exterior tapered surface 742 for contacting a retainer 732. Exterior surface 742 includes threads 743. A tool (not shown) with threads on an interior surface thereof may be threaded onto threads 743 of liner 740. The tool may then be pulled to remove liner 740. Liner 740 and retainer 732 cooperatively function and operate in the same way as the above-described embodiment in order to lock the valve pin in an out-of-service nozzle.

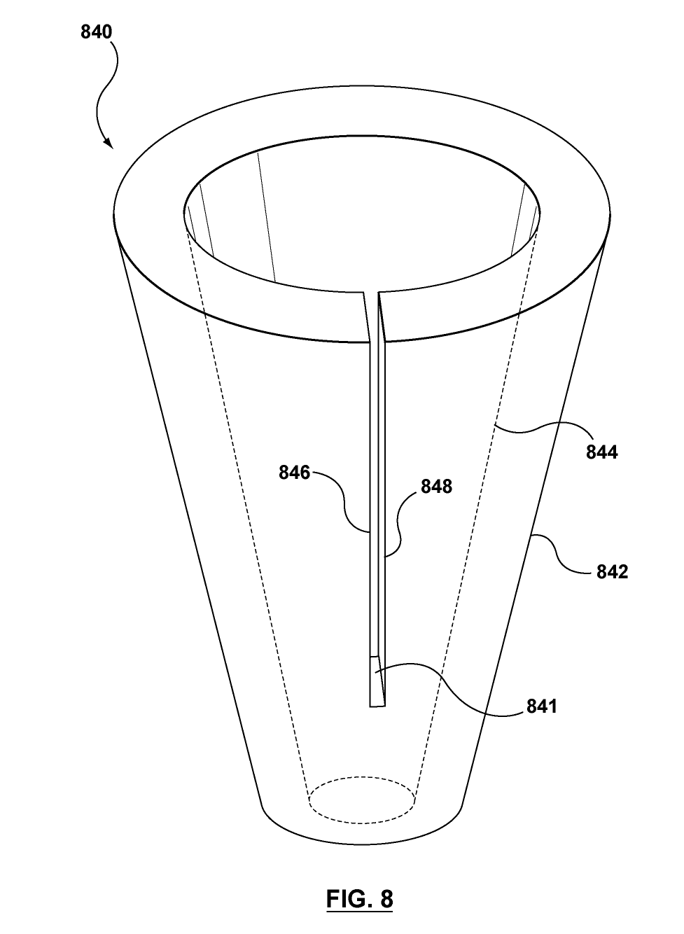

In another embodiment, the locking liner may have a collet-type configuration with a split front. FIG. 8 is a perspective view of a locking liner 840 having a collet-type configuration. Collet-type liner 840 has a cone-type shape (e.g., frusto-conical) and includes one or more slits 841 such that liner 840 may be opened similar to a collet. Although liner 840 includes only one slit 841, it should be noted that the liner may contain multiple slits in order to allow the liner to be opened similar to a collet. Slit 841 extends a portion of the length of liner 840, and may extend from either the top edge of the liner or the bottom edge of the liner. Slit 841 creates a first end 846 and a second end 848. At the out-of-service nozzle tip area, the liner 840 may be opened such that first end 846 is spaced apart from second end 848 and liner 840 is placed around the valve pin. Once in position, the liner 840 is closed such that ends 846,848 of liner 840 touch together and liner 840 surrounds the circumference of the valve pin. Liner 840 has an interior tapered surface 844 for contacting the valve pin (not shown) and an exterior tapered surface 842 for contacting the retainer (not shown). Exterior surface 842 may be smooth as shown or may include one or more threads for easy removal of the liner as described in the embodiment of FIG. 7. Liner 840 grips around the valve pin in a friction fit when the retainer is tightened. Once tightened, the retainer and the liner 840 create a sealed nozzle tip area to prevent leakage/drooling in the out-of-service nozzle.

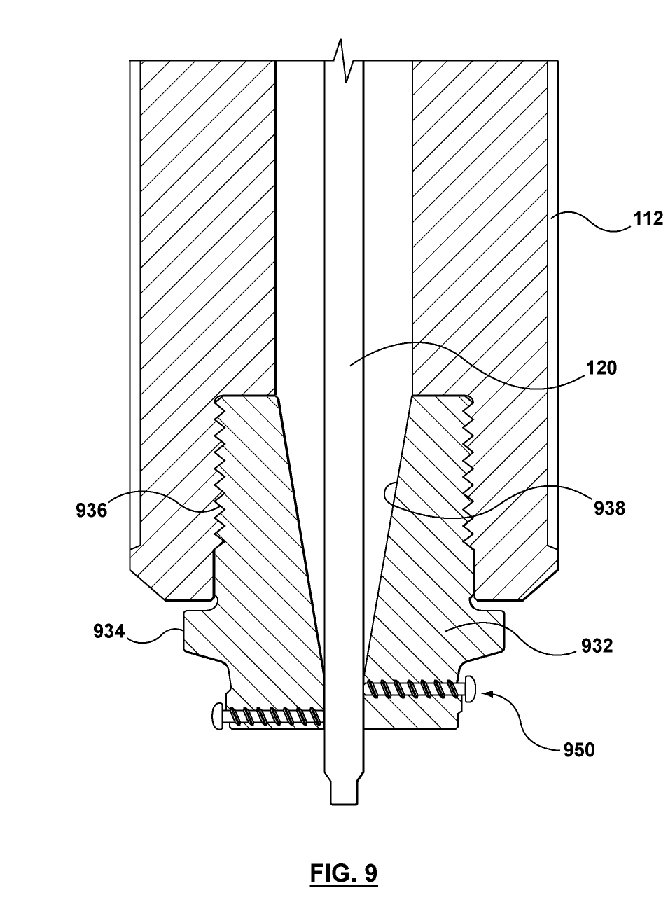

In another embodiment illustrated in FIG. 9, the locking liner of the nozzle tip component may be eliminated and the valve pin may be immobilized by screwing the retainer to the valve pin. FIG. 9 is an enlarged cross-sectional view of the out-of-service nozzle tip area including a retainer 932 to which the valve pin 120 is held with one or more fasteners 950. Retainer 932 may include an interior tapered surface 938 for contacting the valve pin 120 and an exterior surface 934 including one or more threads 936. Threads 936 may be utilized for connecting the retainer to the nozzle 112 and tightening the retainer 932 around the valve pin 120. Fasteners 950 may be screwed through retainer 932, lateral or perpendicular to valve pin 120, for fixing the valve pin 120 to the retainer 932. Once fastened, retainer 932 locks the valve pin 120 in place and creates a sealed nozzle tip area to prevent drooling in the out-of-service nozzle. Fasteners 950 may be any suitable type of mechanical fastener, including but not limited to a screw or screw-like structure. Sealing between the valve pin 120 and the retainer 932 can be achieved by holding suitable tolerances.

In other embodiments, a nozzle tip component is used to grip and lock a valve pin in the closed position, when the valve pin is not used in conjunction with an actuated valve pin plate. For example, a group of valve pins can be individually controlled by actuators that are fed by a common fluid source (e.g., a common air line). In such case, the valve pins will operate together (much like when connected to an actuated plate) and it may be problematic to turn off the specific actuator controlling the valve pin to be taken out of service without turning off all the actuators. Any of the nozzle tip components described herein can be used in this situation to lock the valve pin in the closed position.

In embodiments described herein, supplementary components have been omitted for clarity. For example, a designer may choose to provide many of the threaded components described with lock nuts or another mechanism to stop the threads from working free over time.

In addition, the valve pins described are down-closed and up-open. Reverse gating (up-closed, down-open) and lateral gating (e.g., edge gating) are also possible.

Lastly, the terms fixed, connected, coupled, etc used herein do not exclude indirect connections between parts. For example, a part can be fixed to another part with any number of parts in between or none at all (i.e., directly fixed). In addition, parts described as fixed, connected, coupled, etc can also be integral, if the resulting functionality is not changed.

Although many embodiments of the present invention have been described, those of skill in the art will appreciate that other variations and modifications may be made without departing from the spirit and scope thereof as defined by the appended claims. All patents and publications discussed herein are incorporated in their entirety by reference thereto.

What is claimed is:

1. An injection molding apparatus, comprising:
an actuated valve pin plate;
a manifold defining a manifold channel;
a plurality of nozzles defining nozzle channels in communication with the manifold, each nozzle associated with a mold gate; and
a plurality of valve pins releasably coupled to the actuated valve pin plate, each valve pin extending through the one of the nozzles for controlling flow of molding material in the nozzle channel, the actuated valve pin plate operable to move the plurality of valve pins between open and closed positions of the mold gates,
wherein at least one nozzle includes a nozzle tip component that grips the associated valve pin to lock the valve pin in the closed position.

2. The injection molding apparatus of claim 1, wherein the nozzle tip component includes a liner having a tapered interior surface that circumferentially surrounds the valve pin.

3. The injection molding apparatus of claim 2, wherein the liner is formed from an elastic material that is deformable around the valve pin.

4. The injection molding apparatus of claim 2, wherein the liner has a collet-type configuration with a slit extending a portion of a length of the liner.

5. The injection molding apparatus of claim 2, wherein the liner has an exterior surface including one or more threads.

6. The injection molding apparatus of claim 2, wherein the liner has a tapered exterior surface.

7. The injection molding apparatus of claim 2, wherein the nozzle tip component includes a retainer that is operable to be tightened around the liner.

8. The injection molding apparatus of claim 1, wherein the nozzle tip component includes a retainer fastened to the valve pin.

9. The injection molding apparatus of claim 1, further comprising at least one magnetic coupling that couples the actuated valve pin plate to the valve pin.

10. An injection molding apparatus, comprising:
an actuated valve pin plate;
a manifold defining a manifold channel;
a plurality of nozzles defining nozzle channels in communication with the manifold, each nozzle associated with a mold gate; and
a plurality of valve pins releasably coupled to the actuated valve pin plate, each valve pin extending through the one of the nozzles for controlling flow of molding material in the nozzle channel, the actuated valve pin plate operable to move the plurality of valve pins between open and closed positions of the mold gates,
wherein at least one nozzle includes a nozzle tip component having a tapered interior surface that circumferentially surrounds and grips the associated valve pin to lock the valve pin in the closed position.

11. The injection molding apparatus of claim 10, wherein the nozzle tip component includes an elastic liner that is deformable around the valve pin when a seal is tightened therearound.

12. The injection molding apparatus of claim 11, wherein the liner has an exterior surface including one or more threads.

13. The injection molding apparatus of claim 10, wherein the nozzle tip component is a collet-type configuration with a slit extending a portion of a length of the liner.

14. The injection molding apparatus of claim 10, wherein the nozzle tip component is attached to the valve pin by a screw fastener.

15. The injection molding apparatus of claim 10, further comprising at least one magnetic coupling that couples the actuated valve pin plate to the valve pin.

16. A method for taking a nozzle of a hot runner apparatus out of service, the method comprising the steps of:
moving a valve pin of the nozzle into a closed position to close the nozzle; and
installing a nozzle tip component to grip the valve pin to lock the valve pin in the closed position.

17. The method of claim 16, wherein the nozzle tip component includes a liner that is deformable around the valve pin when a seal is tightened therearound.

18. The method of claim 17, wherein the liner has an exterior surface including one or more threads.

19. The method of claim 16, wherein the nozzle tip component is a collet-type configuration with a slit extending a portion of a length thereof.

20. The method of claim 16, wherein the nozzle tip component is attached to the valve pin by a screw fastener.
